(19) United States
(12) Patent Application Publication
(10) Pub. No.: US 2006/0090190 A1
(43) Pub. Date: Apr. 27, 2006

(54) Multi-channel broadcasting receiver and method for realizing power-saving mode therefor

(76) Inventor: Dong-Uk Seo, Cheonan-si (KR)

Correspondence Address: Robert E. Bushnell, Suite 300, 1522 K Street, N.W., Washington, DC, 20005-1202, US

(21) Appl. No.: 11/258,117

(22) Filed: Oct. 26, 2005

(30) Foreign Application Priority Data
Oct. 27, 2004 (KR) 2004-86358

(51) Int. Cl. H04N 7/16

(52) U.S. Cl. 725/151

(57) ABSTRACT

A multi-channel broadcasting receiver (e.g., a set-top box or STB) and a method for realizing a power-saving mode thereof are provided. The STB includes: an analog broadcasting processor for receiving and outputting an analog broadcast signal; a digital broadcasting processor for receiving and outputting a digital broadcast signal; a broadcasting selector for selecting and outputting one of the analog and digital broadcast signals; a power supply for controlling power supplied to the digital broadcasting processor to realize a power-saving mode; and a controller for controlling the operations of the broadcasting selector and the power supply in response to an external operational signal. The method for realizing the power-saving mode comprises: receiving an external operation signal for selecting a loop-through function; selecting and outputting the signal from the analog broadcasting processor; and blocking power from being supplied to the digital broadcasting processor. Accordingly, power consumption and waste in processing the digital broadcast signal when the analog broadcast signal is being outputted is prevented, and heat generated in the STB is reduced, thereby enhancing the durability of the STB.

### CLAIM OF PRIORITY

This application makes reference to, incorporates the same herein, and claims all benefits accruing under 35 U.S.C. §119 from an application for MULTI-CHANNEL BROADCASTING RECEIVER AND METHOD FOR REALIZING POWER-SAVING MODE THEREFOR earlier filed in the Korean Intellectual Property Office on Oct. 27, 2004 and there duly assigned Serial No. 2004-86358.

### BACKGROUND OF THE INVENTION

1. Technical Field

The present invention relates to a multi-channel broadcasting receiver (e.g., a set-top box that is also hereinafter referred to as ‘STB’) and, more particularly, to a method for realizing a power-saving mode when an analog broadcast signal is received using a multi-channel broadcasting receiver.

2. Description of the Related Art

With the beginning of digital broadcasting service, the number of digital and analog and amounts to 100 or more. In order to receive a number of broadcast signals of such channels, a digital set-top box (STB) is necessarily required.

The digital STB receives a digital broadcast signal from a digital broadcasting provider that provides a digital broadcasting service, and the digital STB processes the digital broadcast signal to output the processed digital broadcast signal to a television or a video tape recorder (VTR). For example, the digital set-top box (STB) demodulates the digital broadcast signal from the digital broadcast provider, encodes the demodulated digital broadcast signal into a national television system committee (NTSC) signal, and outputs the encoded NTSC signal to an output terminal (e.g., an AV terminal). This data processing is hereinafter abbreviated to ‘digital broadcast signal processing’.

Meanwhile, the digital broadcasting provider functions to receive an analog broadcast signal from an analog broadcasting provider, and then to retransmit the analog broadcast signal.

Thus, the digital STB receives the digital broadcast signal that is provided by the digital broadcast provider, as well as the analog broadcast signal (i.e., a radio frequency (RF) broadcast signal), such as a terrestrial broadcast signal, a cable broadcast signal or the like, that the digital broadcasting provider receives from the analog broadcasting provider and retransmits. The STB delivers the analog broadcast signal to the television or the video tape recorder (VTR) via a cable connected to the STB so as to provide the analog broadcast signal to viewers.

This function of the digital STB is normally called ‘RF loop-through’ (also called ‘RF bypass’). The operational mode of the STB is switched by a user's selection.

When the user selects the ‘RF loop-through mode’ as the operation mode of the digital STB, the digital STB receives the analog broadcast signal delivered by the digital broadcasting provider, and delivers the analog broadcast signal to the television or the VTR. In this case, the digital STB merely bypasses the received analog broadcast signal. That is, the digital STB does not perform data processing, such as the above-mentioned ‘digital broadcast signal processing’, on the received analog broadcast signal.

Typically, the digital STB continuously performs ‘digital broadcast signal processing’ as described above on the digital broadcast signal, which is received from the digital broadcast provider, even when the digital STB operates in the RF loop-through mode according to the user's selection.

Accordingly, the digital STB wastes power in performing an unnecessary operation (i.e., ‘digital broadcasting signal processing’) in the ‘RF loop-through mode’. Further, heat generated due to execution of the digital broadcast signal processing degrades durability of the digital STB.

### SUMMARY OF THE INVENTION

The present invention has been made to solve the aforementioned problems. It is an object of the present invention to reduce power consumption in a multi-channel broadcasting receiver, and to enhance durability thereof.

It is another object of the present invention to provide a multi-channel broadcasting receiver capable of realizing a power-saving function in an RF loop-through mode.

It is yet another object of the present invention to provide a method for realizing a power-saving function in a multi-channel broadcasting receiver.

In an aspect of the present invention, there is provided a multi-channel broadcasting receiver which comprises: an analog broadcasting processor for receiving and outputting an analog broadcast signal; a digital broadcasting processor for receiving and outputting a digital broadcast signal; a broadcast selector for selecting and outputting one of the broadcast signals from the analog broadcasting processor and the digital broadcasting processor; a power supply for controlling power supplied to the digital broadcasting processor so as to realize a power-saving mode; and a controller for controlling the operations of the broadcast selector and the power supply in response to an external operational signal.

In another aspect of the present invention, there is provided a method which comprises: receiving an external operation signal for selecting a loop-through function; selecting and outputting the signal from the analog broadcasting processor; and blocking power from being supplied to the digital broadcasting processor.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings in which like reference symbols indicate the same or similar components, wherein:

FIG. 1 conceptually illustrates a procedure for receiving a broadcast signal using a multi-channel broadcasting receiver;

FIG. 2 is a schematic block diagram of a multi-channel broadcasting receiver according to an embodiment of the present invention; and

FIG. 3 illustrates processing performed in a loop-through mode by a multi-channel broadcasting receiver according to an embodiment of the present invention.

### DETAILED DESCRIPTION OF THE INVENTION

The present invention will now be described more fully hereinafter with reference to the accompanying drawings, in which preferred embodiments of the invention are shown. This invention may, however, be embodied in different forms, and should not be construed as limited to the embodiments set forth herein. Rather, these embodiments are provided so that this disclosure will be thorough and complete, and will fully convey the scope of the invention to those skilled in the art. Like numbers refer to like elements throughout the specification.

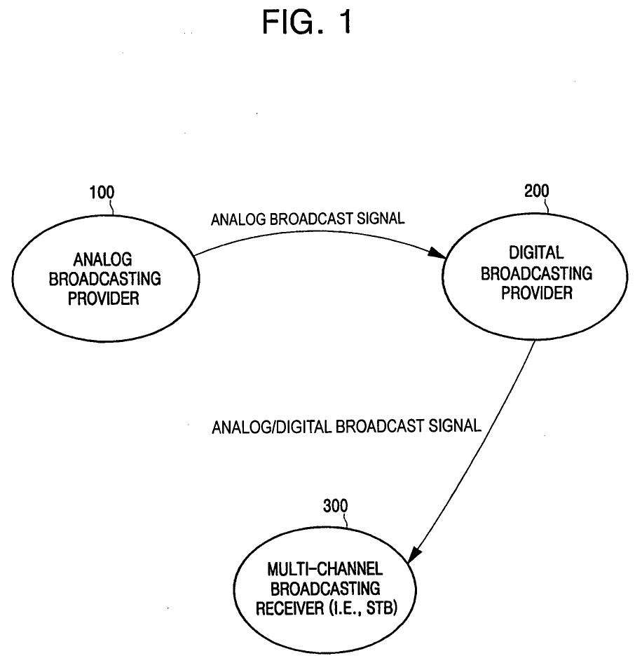

FIG. 1 conceptually illustrates a procedure for receiving a broadcast signal using a multi-channel broadcasting receiver. Referring to FIG. 1, a multi-channel broadcasting receiver (e.g., a set-top box that is also hereinafter referred to as ‘STB’) 300 receives a digital broadcast signal provided by a digital broadcasting provider 200, as well as analog broadcast signal (i.e., radio frequency (RF) broadcasting), such as a terrestrial broadcast signal, a cable broadcast signal or the like, as received by the digital broadcasting provider 200 from an analog broadcasting provider 100 and retransmitted. The STB 300 delivers the analog broadcast signal to a television or a video tape recorder (VTR) via a cable connected to the set-top box (STB) so as to provide analog broadcasting to viewers.

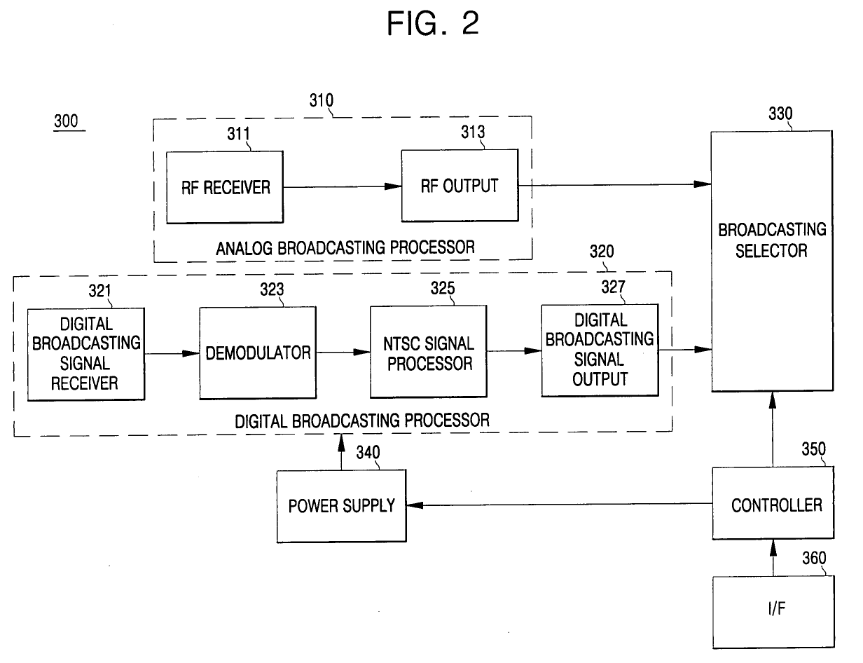

FIG. 2 is a schematic block diagram of a multi-channel broadcasting receiver according to an embodiment of the present invention. Referring to FIG. 2, according to the embodiment of the present invention, the multi-channel broadcasting receiver (i.e., STB) 300 includes an analog broadcasting processor 310, a digital broadcasting processor 320, a broadcasting selector 330, a power supply 340, a controller 350, and an interface (I/F) 360.

The analog broadcasting processor 310 processes an analog broadcast signal which is delivered via the digital broadcasting provider 100 (FIG. 1). The analog broadcast signal does not require performance of separate processing at the STB 300 for output through the television or the VTR. That is, the analog broadcast signal, in its state when received, may be outputted through the television or the VTR as it is. Thus, the analog broadcasting processor 310 bypasses the received analog broadcast signal. In order to realize this functionality, the analog broadcasting processor 310 includes an RF receiver 311 for receiving the analog broadcast signal, and an RF output 313 for outputting the signal.

The digital broadcasting processor 320 processes the digital broadcast signal provided by the digital broadcasting provider 100 (FIG. 1). That is, the digital broadcasting processor 320 converts the digital broadcast signal, delivered by the digital broadcasting provider 100, into a format for output through the television or the VTR. In order to realize this functionality, the digital broadcasting processor 320 includes a digital broadcast signal receiver 321 for receiving the digital broadcast signal, a demodulator 323 for demodulating the received digital broadcast signal, an NTSC signal processor 325 for encoding the modulated signal into a national television system committee (NTSC) signal, and a digital broadcasting signal output 327 for outputting the encoded signal.

Under the control of the controller 350, the broadcasting selector 330 selects one of the broadcast signals received from the analog broadcasting processor 310 and the digital broadcasting processor 320, respectively, and outputs the selected broadcast signal to the television or the VTR.

The power supply 340 supplies power needed to control the operation of the STB 300.

The controller 350 controls the operation of the STB 300 in response to a user's operational signal inputted via the I/F 360. In particular, the controller 350 controls the operation of the broadcasting selector 330 and the power supply 340. For example, in response to the user's operational signal, the controller 350 controls the broadcasting selector 330 so that one of the broadcasting signals from the analog broadcasting processor 310 and the digital broadcasting processor 320 is selected and outputted. The controller 350 also controls the power supply 340 to realize a power-saving mode in the STB 300.

When receiving, via the I/F 360, a loop-through function selecting instruction to output the analog broadcast signal, the controller 350 controls the broadcasting selector 330 such that the broadcast signal inputted via the analog broadcasting processor 310 is outputted. The controller 350 also controls the power supply 340 to block power from being supplied to the digital broadcasting processor 320. This is intended to solve problems (e.g., power waste in the STB 300, durability degradation thereof, and the like) caused by the STB 300 continuously receiving and processing the digital broadcast signal even when the analog broadcast signal is being selected for output.

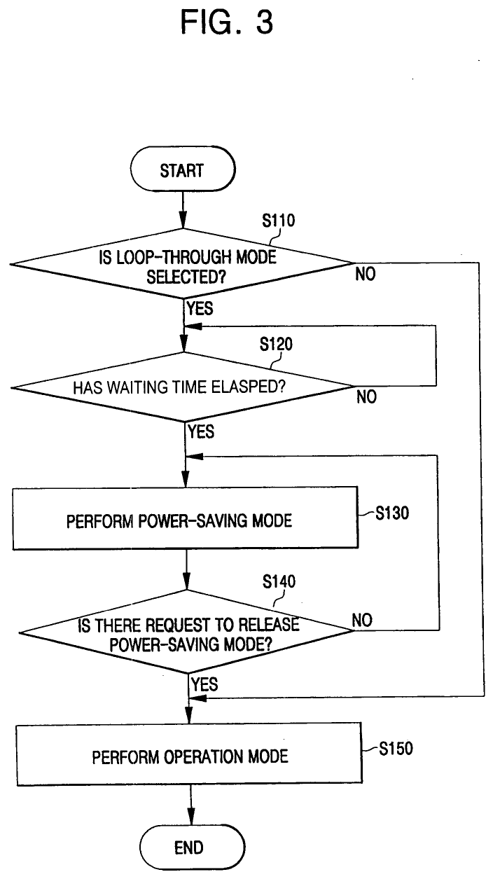

FIG. 3 illustrates processing in a loop-through mode for a multi-channel broadcasting 3 receiver according to an embodiment of the present invention.

According to an embodiment of the present invention, processing when the STB is in the loop-through mode will be discussed with reference to FIG. 3.

First, when a user selects a loop-through mode for receiving an analog broadcast signal (e.g., terrestrial broadcast signal, cable broadcast signal, or the like) by operating a remote control or an STB front-panel switch (S110), the STB 300 waits for a certain period of time (S120), and then performs a power-saving mode (S130). That is, the STB 300 blocks power from being supplied to the digital broadcasting processor 320, so that the digital broadcasting processor 320 does not consume power to generate a digital broadcast signal which will be not supplied to the television or the VTR.

The reason that the STB 300 waits for a certain period of time before entering the power-saving mode is that a switchover to the power-saving mode is not required when the user does not view one channel for a long time, but frequently switches from one channel to other channels.

Furthermore, when the user requests release of the power-saving mode by operating the remote control or the STB front-panel switch (S140), the STB 300 performs its operation mode in response to the request (S150). That is, the STB 300 releases the power-saving mode. For example, when the user releases the loop-through mode, the STB 300 allows the power which was blocked in S130 to be re-supplied. Thus, the STB 300 allows power for processing the digital broadcast signal to be re-supplied.

As described above, the present invention allows receiving and processing of the digital broadcast signal in the STB 300 to be stopped when the analog broadcast signal is selected and outputted. Accordingly, it is possible to advantageously prevent power from being consumed and wasted in processing the digital broadcast signal when the analog broadcast signal is being outputted. Furthermore, this power-saving function enables a reduction in heat generated in the STB 300, thereby enhancing the durability of the STB 300.

Although exemplary embodiments of the present invention have been discussed, it will be apparent that various changes may be made to the present invention without departing from the spirit and scope of the present invention. Therefore, the present invention should not be limited to the illustrated embodiments, but should be determined by the claims and equivalents thereof.

What is claimed is:

1. A multi-channel broadcasting receiver, comprising:
an analog broadcasting processor for receiving and outputting an analog broadcast signal;
a digital broadcasting processor for receiving and outputting a digital broadcast signal;
a broadcasting selector for selecting and outputting one of the broadcast signals outputted by the analog broadcasting processor and the digital broadcasting processor;
a power supply for controlling power supplied to the digital broadcasting processor to realize a power-saving mode; and
a controller for controlling operations of the broadcasting selector and the power supply in response to an external operational signal.

2. The receiver according to claim 1, wherein, when the external operation signal comprise a loop-through function selecting instruction, the controller controls the broadcasting selector so that the broadcasting selector selects the analog broadcast signal outputted by the analog broadcasting processor and controls the power supply to block the power from being supplied to the digital broadcasting processor.

3. The receiver according to claim 2, wherein the analog broadcasting processor bypasses the received analog broadcast signal.

4. The receiver according to claim 2, wherein the digital broadcasting processor comprises:
a digital broadcasting signal receiver for receiving the digital broadcast signal;
a demodulator for demodulating the received digital broadcast signal to produce a demodulated signal;
a signal processor for encoding the demodulated signal to produce a national television system committee (NTSC) signal; and
a digital broadcasting signal output for outputting the NTSC signal.

5. A method for realizing a power-saving mode in a multi-channel broadcasting receiver having an analog broadcasting processor and a digital broadcasting processor for outputting an analog broadcast signal and a digital broadcast signal, respectively, the method comprising the steps of:
receiving an external operation signal for selecting a loop-through function;
selecting and outputting the analog broadcast signal; and
blocking power from being supplied to the digital broadcasting processor.

6. The method according to claim 5, further comprising the step of waiting for a predetermined period of time before blocking the power.

7. The method according to claim 6, further comprising the steps of:
receiving another external operation signal for releasing the loop-through function;
re-supplying the power to the digital broadcasting processor; and
selecting and outputting the digital broadcast signal.
